(19) United States
(12) Patent Application Publication
(10) Pub. No.: US 2010/0267304 A1
(43) Pub. Date: Oct. 21, 2010

(54) POLYURETHANE FOAM PAD AND METHODS OF MAKING AND USING SAME

(76) Inventor: Gregory Fowler, Rocky Face, GA (US)

Correspondence Address: Ballard Spahr LLP, SUITE 1000, 999 PEACHTREE STREET, ATLANTA, GA, 30309-3915, US

(21) Appl. No.: 12/619,059

(22) Filed: Nov. 16, 2009

Related U.S. Application Data
(60) Provisional application No. 61/114,916, filed on Nov. 14, 2008.

(51) Int. Cl. B32B 5/18; B05D 5/00; B32B 3/26; B32B 5/26

(52) U.S. Cl. 442/224; 427/244; 428/304.4; 442/221

(57) ABSTRACT

Disclosed are polyurethane foam pads and methods of making and using same. Also disclosed are processes for making the foam pads, and methods of using the foam pads.

### CROSS-REFERENCE TO RELATED APPLICATIONS

This application claims the benefit of priority to U.S. Provisional Patent Application Ser. No. 61/114,916, filed Nov. 14, 2008, the entire disclosure of which is incorporated by reference herein for all purposes.

### FIELD OF THE INVENTION

The present invention relates generally to polyurethane foam pads that can be used, for example, in combination with textiles, carpeting, or other floor covering applications. Also provided are methods for providing the polyurethane foam pads disclosed herein.

### BACKGROUND OF THE INVENTION

A backing material can be used with a carpet or textile to provide a support, a cushion, a contamination barrier, a moisture barrier, or to simplify installation of the carpet or textile. Backing or support layers often comprise a polyurethane foam. There are several properties of polyurethane foams which are important for determining their usefulness in floor covering applications. These properties can include but are not limited to resiliency, density, thickness, tear strength, tensile strength, dimensional stability, and cost.

Typically, polyurethane foams are manufactured using a double-belted oven conveyer process, wherein two heated belts function as a mold, carrier, and gas barrier for a foam composition. During this process, a conveying foam composition is held between an upper belt and a lower belt. The two belts affect not only the thickness of the foam composite, but also the density. The foam thickness is controlled by the spacing between the two belts. The density is affected by the composition of the belt itself, since as the foam formulation is conveyed to a curing oven, heat permeates through the two belts into the foam, resulting in a cured foam. Thus, the heat capacity or heat transfer capacity of a belt can directly affect the density of the resulting foam product.

Unfortunately, such a belt driven process is limited in a number of ways. For example, the maintenance of a belt driven machine can be difficult and costly. Belts can also require frequent maintenance and oftentimes frequent replacement, and the offline machinery time alone can present substantial economic loss. Additionally, since the belts themselves affect a number of properties of foam composites produced therefrom, the variations and customization of foam composites that can be produced using a belt-driven process are inherently limited.

Accordingly, there is a need to provide improved methods and systems for producing foam composites with desirable densities, preferably in a cost-effective manner. Further, there is a need to provide improved foam composites suitable for use in textile and carpet applications. These needs and other needs are at least partially satisfied by the present invention.

### SUMMARY

Disclosed are polyurethane foam pads and methods of making and using same. Generally, the polyurethane foam pads comprise a cured polyurethane foam layer having a first surface and an opposed second surface. A backing layer contacts the first surface, and a film layer is affixed to the second surface of the cured polyurethane foam layer. The polyurethane foam is formed from a mechanically frothed, chemically blown, or mechanically frothed/chemically blown polyurethane composition.

Also disclosed are processes for making the polyurethane foam pads. Generally, the polyurethane foam pads can be made by providing an uncured foamable polyurethane composition, and applying the foamable polyurethane composition to a surface of a backing material. The applied polyurethane composition can be metered to form a substantially uniform layer of the uncured polyurethane composition having a predetermined thickness. A top layer can be applied to the uncured mechanically frothed and chemically blown polyurethane composition layer. The foamable polyurethane composition can then be cured, to provide a polyurethane foam pad.

Additional embodiments of the invention will be set forth, in part, in the detailed description, figures, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE FIGURES

FIG. 1 is a diagram of a cross-sectional perspective view of a portion of a three-layered foam composite of the present disclosure.

FIG. 2 is a schematic drawing of an exemplary system used to manufacture a three-layered foam composite of the present disclosure.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “surface” includes aspects having two or more such surfaces unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

A weight percent of a component, unless specifically stated to the contrary, is based on the total weight of the formulation or composition in which the component is included.

As used herein, and unless the context clearly indicates otherwise, the term “carpet” is used to generically include broadloom carpet, carpet tiles, and even area rugs. To that end, “broadloom carpet” means a broadloom textile flooring product manufactured for and intended to be used in roll form. “Carpet tile” denotes a modular floor covering, conventionally in 18″×18,″ 24″×24″ or 36″×36″ squares, but other sizes and shapes are also within the scope of the present invention.

The present invention may be understood more readily by reference to the following detailed description of preferred embodiments of the invention and the examples included therein and to the Figures and their previous and following description.

As summarized above, in one broad aspect, the present invention provides a composite comprising an integral foam, such as a polyurethane foam. In general, the disclosed composites can be used in combination with any suitable textile or carpet material. It is contemplated that the composites can be attached or detached to a carpet, textile, or other floor covering. For example, a disclosed composite can be used as a carpet underlay or carpet or textile cushion.

It will be appreciated that the invention is based at least in part on a novel discovery that such a layered approach to a foam composite, when used with a disclosed process, can provide substantially impermeable barrier layers on portions of the foam during the manufacturing process, such that the resulting foam composite has a desired density, including sufficiently low densities.

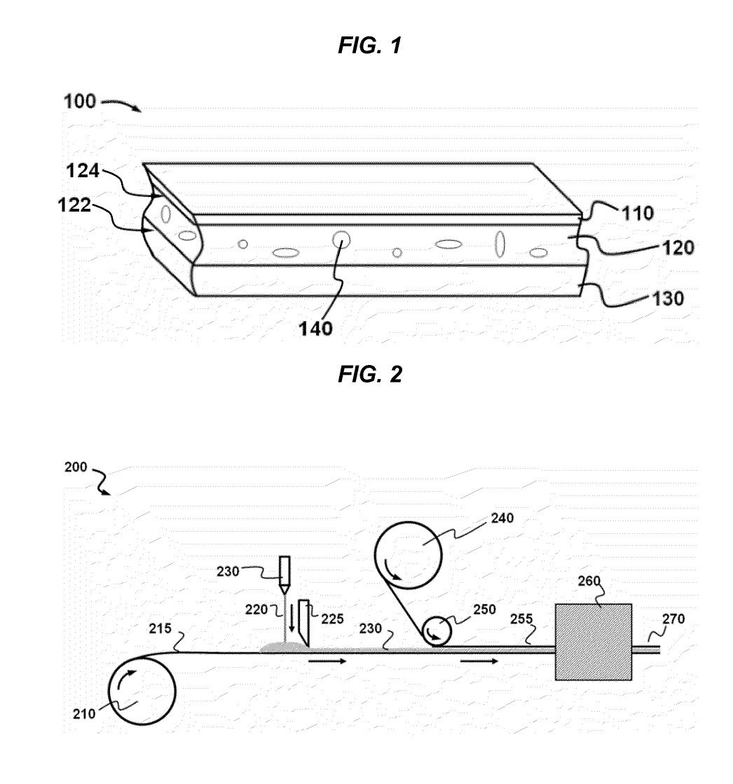

In a first aspect and with reference to FIG. 1, the present disclosure provides generally a laminate polyurethane foam pad 100. The laminate polyurethane foam pad 100 comprises a cured polyurethane foam layer 120 having a first surface 122 and an opposed second surface 124. A backing layer 130 is affixed to the first surface 122 and a laminate face layer 110 is affixed to the second surface 124 such that the polyurethane foam is effectively sandwiched between the backing layer and the laminate face layer.

The cured polyurethane foam layer 120 of the present disclosure can be manufactured according to any conventionally known process and formulation for manufacturing polyurethane foam. For example, and without limitation, the cured polyurethane foam layer 120 can generally be prepared by admixing a first component, such as a polyisocyanate, with a second component, such as an active hydrogen containing material, wherein a gas is introduced therein or produced in situ to form bubbles which in turn form a reduced density expanded cell-like structure in the cured polyurethane. The process of introducing the bubbles is known as mechanically blowing or frothing the formulation. The process of forming bubbles in situ is commonly referred as chemically blowing. The greater the amount of gas introduced into a polyurethane formulation, the lower the density of the resultant foam produced therewith. But with polyurethane foams generally and with polyurethane foams used in floor covering applications in particular, reducing foam density can also decrease or reduce other properties of the polyurethane foam which can make it a desirable material for use in floor covering applications.

In a preferred embodiment, the cured polyurethane foam layer 120 is formed from a polyurethane composition that has been both mechanically frothed and chemically blown, such as those disclosed and described in U.S. Pat. No. 6,372,810, the entire disclosure of which is incorporated by reference herein. Polyurethane foams of this nature can be prepared from formulations comprising a polyisocynate component in combination with relatively high levels of a catalyst, a surfactant, and water. The high level of water can cause a chemical blowing of the foam composition when the water reacts with the polyisocyanate component of the polyurethane formulation. The combination of the mechanical frothing and chemical blowing from the reaction of a polyisocyanate and water results in polyurethane foam having lower densities than those conventionally used in floor covering applications, such as carpet backings and carpet underlays. It should also be appreciated that the polyurethane foams so produced can have sufficiently low densities to be less expensive than conventional polyurethane foams for carpet applications, while maintaining sufficient resiliency and dimensional stability to be desirable for use in various floor covering applications. Such a low density can be achieved for example, by minimizing off-gassing from the polyurethane composition during the curing process, thus providing a cured foam having an expanded cell structure indicated by cells 140 in FIG. 1.

In one aspect, the synergistic combination of mechanical blowing and chemical blowing can be made possible by the inclusion of high levels of catalyst, water, and surfactant in the formulations used to prepare the foams. The foam formulations used to prepare the foams of the present invention can have from about 0.5 to about 3 parts water per hundred parts polyol, preferably from about 0.75 to about 2.75 parts water per hundred parts polyol, and more preferably from about 1.5 to about 2.5 parts water per hundred parts polyol. The formulations of the present invention also include from about 0.01 to about 3.5 parts urethane catalyst per hundred parts polyol, and from 1 to 2 parts surfactant per hundred parts polyol.

The foams can have any desired density, which will depend on the desired use of the foam. In one aspect, the foam can have a density of from about 2 to about 60 pounds per cubic foot, preferably from about 3 to about 30, more preferably from about 6 to about 18, and even more preferably from about 6 to about 14 pounds per cubic foot. For use in a residential floor covering, an exemplary foam can have a density from about 1 to about 10 pounds per cubic foot, including, for example, 2, 4, 6, or 8 pounds per cubic foot. For use in a commercial floor covering, an exemplary foam can have a density from about 11 to about 20 pounds per cubic foot, including, for example, 12, 14, 16, or 18 pounds per cubic foot. Alternatively, for use as a laminate flooring underlayment, an exemplary foam can have a density from about 15 to about 25 pounds per cubic foot, including, for example, 16, 18, 20, 22, and 24 pounds per cubic foot.

The foams can also have any desired thickness, which will generally depend on the composition of the laminate face layer, the backing layer, as well as the amount and composition of polyurethane deposited prior to curing. Exemplary embodiments have thickness of from about 80 mils to about 500 mils, including, without limitation, embodiments having thicknesses of about 90 mils, 100 mils, 120 mils, 140 mils, 160 mils, 180 mils, 200 mils, 240 mils, 250 mils, 280 mils, 320 mils, 350 mils, 400 mils, and 450 mils.

An example formulation suitable to provide the foams includes those formulations disclosed and described in U.S. Pat. No. 5,104,693 (the entire disclosure of which is incorporated by reference herein) but additionally including from about 0.5 to about 3 parts water per hundred parts of polyol, from about 0.01 to about 3.5 parts urethane catalyst per hundred parts of polyol, and from 1 to 2 part surfactant per hundred parts of polyol. In formulations of this type, the polyol component can be at least one isocyanate reactive material having an average equivalent weight of about 1,000 to about 5,000 daltons.

The polyisocyanate can be any polyisocyanate sufficient to provide an isocyanate index of about 90 to about 130, wherein at least 30 percent by weight of the polyisocyanate is a soft segment prepolymer which is the reaction product of a stoichiometric excess of MDI or an MDI derivative and an isocyanate reactive organic polymer having an equivalent weight from about 500 to about 5,000, the prepolymer having an isocyanate group content of about 10 to about 30 percent by weight. The underlay can be prepared by frothing the reactants with air with further blowing as the water reacts with isocyanate to produce carbon dioxide.

Foam formulations of the present invention can comprise a polyol component. The polyol component of the foam formulation can be any polyol or polyol mixture which can be used to prepare a foam which can withstand the physical property and handling requirements of foams used in carpet or textile applications. For example, the polyol component can be a polyol mixture having as one part of the mixture a polyol based on a C₃-C₈ alkylene oxide, which has an equivalent weight of about 1000 to about 5000 daltons, and an internal poly(ethylene oxide) block or a terminal ethylene oxide cap constituting about 15 to about 30 percent of the weight of the polyol, or mixture of such polyols wherein the polyol or mixture thereof has an average functionality of about 1.8 to about 2.5, preferably from about 1.8 to about 2.4 and more preferably from about a 1.8 to about 2.3. The other portion of the polyol mixture is preferably a minor amount of a low equivalent weight compound having about 2 active hydrogen containing groups per molecule.

The polyurethane foams can be prepared with conventional polyurethane catalysts including, but not limited to, tertiary amine catalysts such as triethylenediamine, N-methyl morpholine, N-ethyl morpholine, diethyl ethanolamine, N-coco morpholine, 1-methyl-4-dimethylaminoethyl piperazine, 3-methoxy-N-dimethylpropylamine, N,N-diethyl-3-diethyl aminopropylamine, dimethylbenzyl amine and the like; organotin catalysts such as dimethyltin dilaurate, dibutyltin dilaurate, dioctyltin dilaurate, stannous octoate and the like; and isocyanurate catalysts such aliphatic and aromatic tertiary amine compounds, organotin compounds, alkali metal salts of carboxylic acids, phenols, symmetrical triazine derivatives, and the like.

If an organotin catalyst is used, a suitable cure can be obtained using from about 0.01 to about 0.5 parts per 100 parts of the polyol, by weight. By “suitable cure,” it is meant that a relatively rapid cure to a tack-free state is obtained. If a tertiary amine catalyst is used, the catalyst preferably provides a suitable cure using from about 0.01 to about 3 parts of tertiary amine catalyst per 100 parts of the polyol, by weight. Both an amine type catalyst and an organotin catalyst can be employed simultaneously in any combination or ratio. If a combination of amine catalyst and organotin catalyst is used, the catalysts can be used in an amount of from about 0.02 to about 3.5 parts per 100 parts of polyol, by weight.

The foams can be prepared using both mechanical and chemical blowing agents. The mechanical blowing agent is introduced into a foam forming mixture by a mechanical device. The blowing agent is preferably air, however, other gasses, such as carbon dioxide, nitrogen, and the like can be used. The blowing agent is preferably introduced into the polymer by frothing. A frother is a mechanical device which injects the blowing agent into an admixture as it agitates the admixture. Chemical blowing agents as used herein are volatile materials, or materials that produce gaseous materials as the result of a chemical reaction. Chemical blowing agents useful in the present invention include, for example, liquids such as water, volatile halogenated alkanes such as the various chlorfluoromethanes and chlorfluoroethanes; azo-blowing agents such as azobis(formamide). Water is the preferred chemical blowing agent.

The foams of the present invention are prepared from formulations that can also include fillers. The fillers can be any suitable filler, including, for example, aluminum oxide trihydrate (alumina), calcium carbonate, barium sulfate or mixtures thereof. Other fillers can also be used. The fillers can be virgin, waste material, or even reclaimed fillers. Examples of recycled fillers include coal fly ash, which have been found to be useful in amounts from about 100 to about 400 parts by weight.

In general, the formulations used to prepare the polyurethane foams of the present invention include fillers at any desired level. For example, the amount of filler can be determined relative to parts polyol. To that end, an exemplary polyurethane can have from about 80 parts per hundred parts of polyol to about 250 parts per hundred parts of polyol, including, without limitation, 90, 100, 120, 130, 150, 160, 190, 200, 220, and 140 parts per hundred parts of polyol. Alternatively, the amount of filler can be determined relative to any other desired component of the polyurethane composition, or even relative to the total weight of the polyurethane composition. For example, in an exemplary and non-limiting embodiment, a polyurethane can comprise from about 100 to about 200 parts by weight filler, including, for example, 110, 120, 130, 140, 150, 160, 170, 180, and 190 parts by weight filler, relative to the total weight of the polyurethane.

In one aspect, the polyisocyanate component of the formulations used to prepare the foams can be conveniently selected from organic polyisocyanates, modified polyisocyanates, isocyanate-based prepolymers, and mixtures thereof. These can include aliphatic and cycloaliphatic isocyanates, aromatic and multifunctional aromatic isocyanates. Exemplary polyisocyanates include, but are not limited to, 2,4- and 2,6-toluenediisocyanate and the corresponding isomeric mixtures; 4,4′-, 2,4′- and 2,2′-diphenyl-methanediisocyanate and the corresponding isomeric mixtures; mixtures of 4,4′-, 2,4′- and 2,2′-diphenylmethanediisocyanates and polyphenyl polymethylene polyisocyanates PMDI; and mixtures of PMDI and toluene diisocyanates. Aliphatic and cycloaliphatic isocyanate compounds are also useful for preparing the polyurethanes. Such examples, include 1,6-hexamethylene-diisocyanate; 1-isocyanato-3,5,5-trimethy1-1-3-isocyanatomethyl-cyclohexane; 2,4- and 2,6-hexahydrotoluenediisocyanate, as well as the corresponding isomeric mixtures; 4,4′-, 2,2′- and 2,4′-dicyclohexylmethanediisocyanate, as well as the corresponding isomeric mixtures.

Modified multifunctional isocyanates can also be used, i.e., products which are obtained through chemical reactions of the above diisocyanates and/or polyisocyanates. Examples include polyisocyanates containing esters, ureas, biurets, allophanates and including carbodiimides and/or uretonimines; isocyanurate and/or urethanes containing diisocyanates or polyisocyanates. Liquid polyisocyanates containing carbodiimide groups, uretonimine groups and/or isocyanurate rings, having isocyanate groups (NCO) contents (42/polyisocyanate mwt) of from about 10 to about 40 weight percent, or from about 20 to about 35 weight percent, can also be used. These include, for example, polyisocyanates based on 4,4′-, 2,4′- and/or 2,2′-diphenylmethane diisocyanate and the corresponding isomeric mixtures, 2,4- and/or 2,6-toluenediisocyanate and the corresponding isomeric mixtures; mixtures of diphenylmethane diisocyanates and PMDI and mixtures of toluenediisocyanates and PMDI and/or diphenylmethane diisocyanates.

Prepolymers can also be useful with the formulations used to prepare the foams. In one aspect, suitable prepolymers are prepolymers having NCO contents of from about 5 to about 40 weight percent, more preferably from about 15 to about 30 weight percent. These prepolymers are prepared by reaction of the di- and/or polyisocyanates with materials such as lower molecular weight diols and triols, but also they can be prepared with multivalent active hydrogen compounds such as di- and tri-amines and di- and tri-thiols. Specific examples include aromatic polyisocyanates containing urethane groups, having NCO contents of from about 5 to about 40 weight percent, or about 20 to about 35 weight percent, obtained by reaction of diisocyanates and/or polyisocyanates with, for example, lower molecular weight diols, triols, oxyalkylene glycols, dioxyalkylene glycols or polyoxyalkylene glycols having molecular weights up to about 800. These polyols can be employed individually or in mixtures as di- and/or polyoxyalkylene glycols. For example, diethylene glycols, dipropylene glycols, polyoxyethylene glycols, polyoxypropylene glycols and polyoxypropylenepolyoxyethylene glycols can be used.

Polyisocyanates having an NCO content of from 8 to 40 weight percent containing carbodiimide groups and/or urethane groups, from 4,4′-diphenylmethane diisocyanate or a mixture of 4,4′- and 2,4′-diphenylmethane diisocyanates can also be used with the formulations. Additionally, prepolymers containing NCO groups, having an NCO content of from about 20 to about 35 weight percent, based on the weight of the prepolymer, prepared by the reaction of polyoxyalkylene polyols, having a functionality of from 2 to 4 and a molecular weight of from about 800 to about 15,000 with 4,4′-diphenylmethane diisocyanate or with a mixture of 4,4′- and 2,4′-diphenylmethane diisocyanates and mixtures of polyisocyanates and prepolymers; and 2,4- and 2,6-toluene-diisocyanate or the corresponding isomeric mixtures. PMDI in any of its forms can also be used. PMDI can have an equivalent weight of from about 125 to about about 300, or from about 130 to about 175, with an average functionality of greater than about 2. An average functionality can also be from about 2.5 to about 3.5. The viscosity of the polyisocyanate component can be from about 25 to about 5,000 centipoise (cps) (0.025 to about 5 PaYs), but values from about 100 to about 1,000 cps at 25.degree. C. (0.1 to 1 PaYs) are also useful for ease of processing. Similar viscosities are useful where alternative polyisocyanate components are selected. In one aspect, the polyisocyanate component of the formulations of the present invention is selected from MDI, PMDI, an MDI prepolymer, a PMDI prepolymer, a modified MDI, and a combination thereof.

Polyfunctional active hydrogen containing materials useful with the present formulations can include materials other than those described above. Active hydrogen containing compounds commonly used in polyurethane production are those compounds having at least two hydroxyl groups. Those compounds are referred to herein as polyols. Representatives of suitable polyols are generally known and are described in such publications as High Polymers, Vol. XVI, “Polyurethanes, Chemistry and Technology” by Saunders and Frisch, Interscience Publishers, New York, Vol. I, pp. 32-42, 44-54 (1962) and Vol. II, pp. 5-6, 198-199 (1964); Organic Polymer Chemistry by K. J. Saunders, Chapman and Hall, London, pp. 323-325 (1973); and Developments in Polyurethanes, Vol. I, J. M. Burst, ed., Applied Science Publishers, pp. 1-76 (1978). However, any active hydrogen containing compound can be used with the present invention. Examples of such materials include those selected from the following classes of compositions, alone or in admixture: (a) alkylene oxide adducts of polyhydroxyalkanes; (b) alkylene oxide adducts of non-reducing sugars and sugar derivatives; (c) alkylene oxide adducts of phosphorus and polyphosphorus acids; and (d) alkylene oxide adducts of polyphenols. Polyols of these types are referred to herein as “base polyols”. Examples of alkylene oxide adducts of polyhydroxyalkanes useful herein are adducts of ethylene glycol, propylene glycol, 1,3-dihydroxypropane, 1,4-dihydroxybutane, and 1,6-dihydroxyhexane, glycerol, 1,2,4-trihydroxybutane, 1,2,6-trihydroxyhexane, 1,1,1-trimethylolethane, 1,1,1-trimethylolpropane, pentaerythritol, polycaprolactone, xylitol, arabitol, sorbitol, mannitol, and the like. Examples of alkylene oxide adducts of polyhydroxyalkanes are the ethylene oxide adducts of trihydroxyalkanes. Other useful adducts include ethylene diamine, glycerin, ammonia, 1,2,3,4-tetrahydroxy butane, fructose, and sucrose.

Also useful are poly(oxypropylene) glycols, triols, tetrols and hexols and any of these that are capped with ethylene oxide. These polyols also include poly(oxypropyleneoxyethylene)polyols. The oxyethylene content conveniently comprise less than about 80 weight percent of the total polyol weight, or less than about 40 weight percent. The ethylene oxide, if used, can be incorporated in any way along the polymer chain, for example, as internal blocks, terminal blocks, or randomly distributed blocks, or any combination thereof.

Polyamines, amine-terminated polyols, polymercaptans and other isocyanate-reactive compounds are also suitable for use with the disclosed formulations. Polyisocyanate polyaddition active hydrogen containing compounds (PIPA) are particularly preferred for use with the present invention. PIPA compounds are typically the reaction products of TDI and triethanolamine. A method for preparing PIPA compounds can be found in, for example, U.S. Pat. No. 4,374,209, issued to Rowlands.

Another preferred class of polyols are “copolymer polyols”, which are base polyols containing stably dispersed polymers such as acrylonitrile-styrene copolymers. Production of these copolymer polyols can be from reaction mixtures comprising a variety of other materials, including, for example, catalysts such as azobisisobutyro-nitrile; copolymer polyol stabilizers; and chain transfer agents such as isopropanol. Polyols comprising natural oils such as soy, sunflower, and safflower oil can be desirable in combination with standard petroleum based polyols. It should be appreciated that such oils can help to offset the overall carbon footprint of the product.

With reference again to FIG. 1, the cured polyurethane foam layer 120 is sandwiched between a backing layer 130 and a laminate face layer 110. To that end, the backing layer 130 can be any substrate material including woven and non-woven textile fabrics, or a combination of woven and non-woven fabrics. In one aspect, the backing layer comprises a thermoplastic material. Suitable thermoplastic materials include, without limitation, asphalt such as natural asphalt, petroleum asphalt, polyolefins such as polyethylene, polypropylene, ethylene-propylene copolymer, ethylene-butene copolymer, olefin-polar monomer copolymers such as ethylene-vinyl acetate copolymer, ethylene-acrylic ester copolymer, and chlorinated polymers such as polyvinyl chloride, and polyethylene chloride. The backing layer can comprise woven fabrics, bound fabrics, or nonwoven fabrics prepared from a suitable material.

For example, according to some exemplary embodiments, the backing layer 130 can be a woven or non-woven polymeric scrim material. Exemplary woven polymeric scrims can include woven polypropylene primary backing materials. When the backing is a woven textile fabric, such as the exemplary woven polypropylene primary backing, the textile can be formed as flat weave comprised of tape yarns, spun yarns, or a combination of both tape and spun yarns. Still further, suitable woven polypropylene materials can have from 24 to 32 warp threads (threads in the longitudinal direction) per inch and from 10 to 22 weft threads (threads drawn over and under the warp threads to form the fabric weave) per inch. In an exemplary preferred embodiment, the woven polymeric fabric comprises 28 warp threads and 10 weft threads per square inch of fabric. In an alternative preferred embodiment, the woven polymeric fabric comprises 28 warp threads and 12 weft threads per square inch of fabric. An example of a commercially available polypropylene material is a (28×10) woven polypropylene flat weave S7704 as supplied by Sythetic Industries (12454 N Highway 27, Chickamauga, Ga., 30707, U.S.A.)

As noted, the backing can also be a non-woven textile material. Exemplary non-woven textile materials include spun-bonded textiles, hydro-entangled textiles, thermally bonded textiles, wet-laid, melt-blown, air entangled, and needle-punched textiles. In still other embodiments, the backing material can be a combination of woven and non-woven textile materials. For example, in an embodiment the backing can be a fleeced woven primary backing material, whereby a polymeric woven textile is needle-punched with staple fibers to provide a fleeced woven backing material such as a fleeced backing material manufactured by Propex Fabrics, Style 4005 (24×10 FLW) (Dalton, Ga. U.S.A.).

The backing material can comprise virgin, recycled, waste material, or a combination thereof. For example, in a preferred embodiment, the backing material can comprise one or more polymeric materials reclaimed from prior manufactured carpet or other floor covering components. The prior manufactured carpet or other floor covering can include post consumer, post commercial, post residential, post industrial, manufacturing remnants, quality control failures, and the like. Such reclaimed material can be present in the backing material in percentages ranging from 0 up to 100%. For example, a backing material can comprise 10%, 20%, 50%, 40%, 60%, 80%, or 100% post residential or post consumer carpet products. In one exemplary embodiment, a backing layer comprises at least about 50% reclaimed material, such as post consumer carpet material, post industrial carpet material, post commercial carpet material, or a combination thereof.

The backing layer can be any suitable size or weight, depending on the desired application of the composite. In some embodiments, the backing layer has a weight of about 2 to about 4 ounces per square yard. Exemplary embodiments of the backing layer include 28×10 (10 pic) backings at 3 ounces per square yard, 28×13 (13 pic) backings at 3.5 ounces per square yard, and 28×15 (15 pic) backings at 3.75 ounces per square yard.

With reference again to composite structure depicted in FIG. 1, the laminate face layer 110 can similarly be any one of the materials described above as suitable for use as the backing material. Alternatively, the laminate face layer 110 can be any polymeric sheet material, such as a polymeric film. In a preferred embodiment, the laminate face layer is a high density cross laminated polyethylene film such as product “RXHT505” commercially available from Interplast Group (9 Peach Tree Hill Road, Livingston, N.J. 07039, U.S.A.). In an alternative embodiment, it is contemplated that the laminate face layer can comprise a combination of a non-woven or woven textile together with a polymer sheet material. For example, the laminate face layer can be a CLAF® fabric available from Atlanta Nisseki CLAF, Inc. (ANCI) of Kennesaw, Ga. USA. The CLAF® fabrics are generally a cross laminated polyethylene open mesh non-woven fabric which exhibit relative high strength in both the machine and cross directions, are relatively light weight, exhibit a thin profile, have relatively high tear resistance, and exhibit dimensional stability. The CLAF® fabric can optionally have good breathability, depending on whether or not the fabric has an extruded coating.

The laminate face layer can have any suitable weight and thickness. In some embodiments, the laminate face layer has a weight of from about 0.2 ounces per square yard to about 1.0 ounce per square yard, including, without limitation, laminate face layers having a weight of about 0.3, 0.4, 0.5, 0.6, 0.7, 0.8, and 0.9 ounces per square yard. In a further aspect, a laminate face layer can have a thickness of from about 1 mil to about 3 mil, including, without limitation, 1.5 mil, 2 mil, and 2.5 mil thickness, although virtually any thickness can be used.

The composite polyurethane foam structures disclosed herein are suitable for use as a detached underlay for use in connection with virtually any floor covering application, including without limitation, wood flooring, laminate flooring, sheet resilient flooring, residential carpeting, industrial carpeting, commercial carpeting, broadloom carpeting, carpet tiles, tufted carpets, needle-punched carpets, hand woven carpets, broadloom carpets, automotive carpets, carpet tiles, and even area rugs. Other suitable textiles include fabrics for automotive trim, and automotive trunk liners, synthetic playing surfaces, woven polymeric scrim, non woven polymeric scrim, wall coverings, sheet polymers, furniture covers, and the like.

Alternatively, the composite polyurethane foam structures are also suitable for use as an attached pad wherein the composite structure depicted generally in FIG. 1 is integral to a pre-manufactured floor covering. According to this aspect, either the backing layer 130 or the laminate face layer 110 can be integral to or a component layer of a pre-manufactured floor covering material such as, for example, a broadloom carpet or a carpet tile.

It will be apparent that the composite polyurethane foam structures exhibit a number of advantages over foam structures known in the art. In one aspect, the composite foam structures can provide improved dimensional stability (i.e., the ability of a material to retain its shape and size) to floor coverings under end-use conditions. A flooring underlayment lacking suitable dimensional stability tends to ripple, buckle, and can even change in size over time due to changes in temperature, humidity, high traffic, heavy rolling, and the like. However, the present foam structures feature a laminate face layer and a backing layer affixed to the foam layer, which can provide additional dimensional strength to the foam layer, and thereby provide additional overall dimensional strength to the composite polyurethane foam product.

The composite foam structures can also provide floor coverings and floor covering underlayers having improved humidity and moisture resistance. Humidity and moisture damage can damage floor coverings and can even lead to other long-term problems, such as indoor mold. However, a disclosed three-layered composite structure provides a substantial barrier around the foam layer (i.e., on the top and bottom of the foam layer), thereby substantially preventing water permeability into the foam composite from the undersurface and oversurface of the floor covering.

It will also be apparent that the present film layers can function as an improved slip layer for a composite structure when used as a detached underlay for a floor covering. As opposed to a typical underlay, wherein the foam directly contacts the bottom surface of the floor covering, the present composites allow for separation between the foam and the floor covering. Such a configuration could be especially desirable for foams that tend to buckle or ripple in response to stretching or movement of a floor covering during installation. Thus, the film layer can function as a more frictionless surface, allowing the floor covering to move or stretch as needed during installation, without disturbing the underlay.

The composite structures also provide improved resistance to tearing, which can have benefits during installation and during end-uses. For example, conventional rebond polyurethane foam having no backing layer or laminate face layer relies purely on the strength of the foam itself to remain stapled or adhered to a subfloor, which is often insufficient and results in tearing around or near the point of attachment to the subfloor. Such attachment can be achieved by stapling, applying an adhesive layer, or any other means known in the art. However, according to the present embodiments, the integrity of the composite product is improved by the presence of the more durable backing layer, laminate face layer, or the combination thereof, which are themselves more resistant to tearing than the foam layer. As a result, the tear and tensile strength of the composite is substantially improved relative to a conventional rebond foam having no backing or laminate face layer. As a specific example, a typical foam rebond material with a 6.5 lbs. per cubic foot density has a tensile strength of about 6.0 lbs, according to the ASTM-D3574 or ASTM-D2646 test, whereas tensile strengths greater than 39 lbs. have been achieved with the present composites. To that end, a foam composite can exhibit any desired tensile strength, including, for example, greater than about 6, 10, 15, 20, 30, 40, 45, 50 lbs. as measured by ASTM-D3574 or ASTM-D2646 test. Tongue tear strength is likewise improved. A typical foam rebond material with a 6.5 lbs. per cubic foot density exhibits a tear strength of about 1.265 lbs. whereas tear strengths of 28.0 lbs or greater have been achieved with the present composites, according to the ASTM-D5117 test. To that end, a foam composite can exhibit any desired tongue tear strength, including, for example, greater than about 6.5, 7, 10, 12, 15, 20, 22, 25, 30, 35 lbs. as measured by ASTM-D5117.

The composite structures can also exhibit unique properties on opposite sides of the composite, depending on the choice of backing and laminate face layer present on the composite, For example, by using different materials for the backing layer and the film layer, each side can exhibit different properties. Such properties include, without limitation, slip resistance, water permeability, heat capacity, impression and/or compression strength, among others. For example, the laminate face layer side of an 8 lbs. per cubic foot density pad, at 7/16 inches in thickness, can exhibit a firmness factor, measured as compression force deflection (CFD) according to the ASTM-D3574 test, of from about 1.4 to about 1.7 lbs. per square inch at 25% compression, and 6.0 to 7.0 pounds per square inch at 65% compression. In contrast, the backing layer side of the same pad can exhibit a firmness factor of 20 to 40% greater than the firmness factor of the laminate face layer side. Exhibiting such dual properties can be useful in a variety of instances. For example, a single product can provide an end-user with a choice of installation, whereby the user can experience a different firmness factor depending on which side of the foam composite is adjacent the flooring. Further, the firmness factors of conventional foams are dependant on the density of the foam itself. To that end, conventional foams are typically more expensive as the desired density level increases. However, by exhibiting dual properties, a foam convention as disclosed herein can exhibit varying firmness factors without having to increase the cost to the consumer.

In addition and as will be described in more detail in connection with the process for manufacture detailed, the pic-count of a material, such as a woven polypropylene material, can influence the properties (e.g., thickness, density, compressibility, etc.) of the foam layer. In general, a material with a tighter weave (i.e., materials having very little spacing between warp and weft threads), with provide a foam composite with a lower density than a material with a looser weave, given that a looser weave allows more gas to escape the uncured polyurethane foam composition.

The present invention further provides a process for manufacturing the laminate polyurethane foam pads disclosed and described herein. Generally, with reference again to FIG. 1, the process involves applying a foam formulation to a backing layer 130, adjusting the thickness of the foam formulation, and subsequently applying a film layer 120 to the foam formulation. Once the film layer is applied, the composite is cured to provide a composite as depicted in FIG. 1.

The foam formulation, as discussed above, can be an uncured mechanically frothed and chemically blown polyurethane composition. In some embodiments, it can be preferable to premix all of the components of the foam formulation except polyisocyanate (and the blowing agent when a gas is used). The polyisocyanate and other components, as discussed above, can first be admixed and then the blowing agent gas can be blended in using, for example, a mixer, such as an Oakes Frother (available from the E. T. Oakes Corporation, Hauppauge, N.Y.) Variable speed pumps can be used to transport the separate components to the mixer. The composition can then be applied to a backing layer prior to curing.

With reference to FIG. 2, a backing material 215 can be conveyed using a tenter apparatus (not shown) from a roll 210. The uncured mechanically frothed and chemically blown polyurethane composition 220 can be applied to the backing material 215 from a foam applicator 230. The applied foam formulation can then be metered to a desired thickness and uniformity using a blade 225, such as an air blade, a knife blade, an extruder blade, or a doctor blade, to provide an uncured mechanically frothed and chemically blown polyurethane composition layer 230. The film layer 255 can then be applied to the uncured mechanically frothed and chemically blown polyurethane composition layer 230. Finally, the mechanically frothed and chemically blown polyurethane layer can be cured in a curing oven 260, at a temperature of from about 200° F. to about 300° F.

The speed of the process can vary depending on the desired properties of the composite and/or manufacturing constraints. In preferred embodiments, the tenter speed is held at from about 5 feet per minute to about 60 feet per minute, or from about 10 feet per minute to about 50 feet per minute, or from about 15 feet per minute to about 40 feet per minute, or more preferably 25 feet per minute to 45 feet per minute.

The curing step can be carried out in any suitable oven, including, without limitation, a single, or multiple pass (including a double, or triple-pass oven, an infrared oven, an open flamed oven, and an open flamed forced draft convection impingement oven, or simply with a heating plate, the selection of which can depend, in one aspect, on available space at a manufacturing facility. In a preferred embodiment, the curing step is carried out in a triple-pass oven, for example, but without limitation, a 100 foot triple pass oven.

As will be apparent, the present composite structures are uniquely compatible with tenter-based machinery. It should be appreciate that the use of a tenting apparatus can provide advantages over using other manufacturing equipment, including belt-driven machinery. For example, a tenting apparatus does not require the use of a belt, which can be costly to maintain and replace, since the offline machinery time alone can present substantial economic loss.

In addition, the versatility of composite structures that can be produced by a belt-driven process is limited. With a double belt-driven process, the belts themselves provide a gas impermeable barrier to the foam layer. The belt coatings provide a substantially constant gas impermeability, such that resulting foam composites have similar densities. To replace such coatings in order to provide composites with varying densities would be too costly. In accordance with the present methods, however, a backing layer and a film layer, as opposed to a belt, can provide gas impermeable layers when used with a tenting apparatus. As discussed above, the backing layer and the film layer can comprise a variety of different materials, all with varying levels of gas permeability. Thus, composite structures with varying density levels can be provided by simply changing the properties of the layer and the film layer, without substantially altering manufacturing conditions.

Furthermore, the present methods provide improved heat transfer from the curing oven to the foam layer by using a tenter apparatus in combination with a three-layer structure. Heat transfer is limited in a belt-driven process by the heat transfer capacity of the belts themselves, whereas according to the present methods, differing degrees of heat transfer can be accomplished by simply utilizing different materials as the backing layer and/or the film layer, as discussed above.

### EXAMPLES

To further illustrate the principles of the present invention, the following examples are put forth so as to provide those of ordinary skill in the art with a complete disclosure and description of how the various aspects of the invention disclosed herein can be made and/or evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is degrees F. or is at ambient temperature, and pressure is at or near atmospheric or full vacuum.

### Example 1

### Representative Formulation for Providing a Foam

Approximately 46 parts of a 10 percent ethylene oxide capped propylene oxide polyol having di-hydroxy functionality and a molecular weight of 2,000, hereinafter referred to as “the Diol;” 46 parts of an ethylene oxide, propylene oxide heteropolyol wherein the ratio of ethylene oxide to propylene oxide can be 8:92 and the polyol has tri-hydroxy functionality and a molecular weight of 3,000; and 8 parts of diethylene glycol can be admixed. Into this mixture can be further admixed 190 parts calcium carbonate. The admixture can then be mixed and heated to 120° F. (48.9° C.) and then allowed to cool to 72° F. (22.2° C.) and is hereinafter referred to as Mixture A.

290 parts of Mixture A can be admixed with: 1.8 parts of 1.25 percent solution of UL-6* in the Diol; 9 parts of a solution of 20 percent water dissolved in the Diol; 7.5 parts of a 20 percent solution of L5614 silicone surfactant* dissolved in the Diol; and 73 parts of an MDI prepolymer prepared by reacting a 45:55 mixture of dipropylene glycol and tripropylene glycol with MDI and a PMDI having an isocyanate functionality of 2.3 and a 14 percent o′p′-MDI isomer content, wherein the MDI prepolymer has an isocyanate content of 27.5 percent. This admixture is hereinafter referred to as Mixture B. *(UL-6 is a trade designation of Whitco Chemical Corp. and has the chemical name: diisooctylmercaptoacetate; L5614 silicone surfactant is a trade designation of OSI Specialties Inc. and is a linear siloxane—polyoxyalkylene block copolymer having an average molecular weight of about 100,00.)

Mixture B can be frothed using compressed air and an Oakes Frother (available from the E. T. Oakes Corporation, Hauppauge, N.Y.). The resulting froth has a density of about 422 g/I. The froth can be applied to a disclosed carrier using methods known in the art, or disclosed methods.

### Example 2

### Manufacture of Polyurethane Foam Composite

A 10-pic polypropylene flat weave carrier (28 warp×10 weft) with a weight of about 3 ounces per square yard was preheated at from 70° F. to 196° F. while being conveyed on a tenter. A mechanically frothed/chemically blown foam composition, such as those disclosed herein, was applied to the polypropylene flat weave. Approximately 39 ounces of foam was applied to each square yard of carrier material. The line conveying speed was kept at about 36.7 feet per minute. The applied foam composition was metered to a thickness of about 120 mils prior to curing. A polymer film (XF film style RX HT505), from Interplast Group, 9 Peach Tree Hill Road, Livingston, N.J. 07039, U.S.A.) was applied to the metered foam composition. The resulting pre-composite was cured in a 100 foot triple pass oven at a temperature of about 250° F. to about 280° F. After curing, the composite had a thickness of about 7/16 inches (11.11 millimeters) and a density of about 8 pounds per cubic foot.

### Example 3

### Fleece-Foam Composite

A fleeced-foam composite was prepared as in Example 2, with a 10-pic fleeced woven carrier (FLW) which comprised about 3 ounces per square yard of 10-pic polypropylene flat weave and about 1.5 ounces per square yard needle-punched fleece, for a combined carrier weight of about 4.5 ounces per square yard.

The fleeced carrier was preheated at from 70° F. to 196° F. while being conveyed on a tenter. A mechanically frothed/chemically blown foam composition, such as those disclosed herein, was applied to the carrier. Approximately 39 ounces of foam was applied to each square yard of carrier material. The line conveying speed was kept at about 36.7 feet per minute. The applied foam composition was metered to a thickness of about 120 mils prior to curing. A polymer film (XF film style RX HT505), from Interplast Group, 9 Peach Tree Hill Road, Livingston, N.J. 07039, U.S.A.) was applied to the metered foam composition. The resulting pre-composite was cured in a 100 foot triple pass oven at a temperature of about 250° F. to about 280° F. After curing, the composite had a thickness of about 11/32 inches (˜8.7 millimeters).

### Example 4

### Tape/Yarn-Foam Composite A

A foam composite was prepared as in Example 2, using 12-pic (28×12 warp-weft) tape and spun yarn polymeric woven backing, having a weight of about 3.2 ounces per square yard. The backing was preheated at from 70° F. to 196° F. while being conveyed on a tenter. A mechanically frothed/chemically blown foam composition, such as those disclosed herein, was applied to the backing. Approximately 39 ounces of foam was applied to each square yard of carrier material. The line conveying speed was kept at about 36.7 feet per minute. The applied foam composition was metered to a thickness of about 120 mils prior to curing. A polymer film (XF film style RX HT505), from Interplast Group, 9 Peach Tree Hill Road, Livingston, N.J. 07039, U.S.A.) was applied to the metered foam composition. The resulting pre-composite was cured in a 100 foot triple pass oven at a temperature of about 250° F. to about 280° F. After curing, the composite had a thickness of about 4/32 inches (˜3.2 millimeters).

### Example 5

### Tape/Yarn-Foam Composite B

A foam composite was prepared as in Example 2, using 10-pic (28×10 warp-weft) tape and spun yarn polymeric woven backing, having a weight of about 3 ounces per square yard. The backing was preheated at from 70° F. to 196° F. while being conveyed on a tenter. A mechanically frothed/chemically blown foam composition, such as those disclosed herein, was applied to the backing. Approximately 39 ounces of foam was applied to each square yard of carrier material.

The line conveying speed was kept at about 36.7 feet per minute. The applied foam composition was metered to a thickness of about 120 mils prior to curing. A polymer film (XF film style RX HT505), from Interplast Group, 9 Peach Tree Hill Road, Livingston, N.J. 07039, U.S.A.) was applied to the metered foam composition. The resulting pre-composite was cured in a 100 foot triple pass oven at a temperature of about 250° F. to about 280° F. After curing, the composite had a thickness of about 7/64 inches (˜2.8 millimeters).

As can be seen from the above Examples, the backing layer and/or the laminate face layer can affect the density (which is reflected in the thickness) of the resulting polyurethane foam. Without wishing to be bound by theory, it is believed that as the gas permeability of at least the backing layer and/or the laminate face layer decreases, the overall polyurethane foam composite density, reflected in the overall composite thickness, decreases since less gas escapes from the foamable composition prior to and during curing. For example, as can be seen from Example 2, a flat weave polypropylene comprised of tape yarns, which is an example of a relatively less permeable (i.e., tightly weaved) backing layer, results in a thicker product relative to a product having a spun yarn containing backing layer as in Examples 4 and 5.

What is claimed is:

1. A laminate polyurethane foam pad, comprising:
a cured polyurethane foam layer having a first surface and an opposed second surface, wherein the polyurethane foam is formed from a mechanically frothed and chemically blown polyurethane composition;
a backing layer contacting to the first surface of the cured polyurethane foam layer; and
a film layer affixed to the second surface of the cured polyurethane foam layer.

2. The composite polyurethane foam pad of claim 1, wherein the backing layer is comprised of a woven textile material.

3. The composite polyurethane foam pad of claim 2, wherein the woven textile material is comprised of polypropylene.

4. The composite polyurethane foam pad of claim 2, wherein the woven textile material is a flat weave woven textile.

5. The composite polyurethane foam pad of claim 2, wherein both the first and second laminate layers are comprised of a woven textile material.

6. The composite polyurethane foam pad of claim 2, wherein the second laminate layer is a polymeric film.

7. The composite polyurethane foam pad of claim 6, wherein the polymeric film is comprised of polyethylene.

8. The composite polyurethane foam pad of claim 1, wherein the cured polyurethane foam layer has a thickness of from about 80 mils to about 500 mils.

9. The composite polyurethane foam pad of claim 1, wherein the cured polyurethane foam layer has a density of from about 5 to about 15 pounds per cubic foot.

10. A process for preparing a composite polyurethane foam pad, comprising
providing an uncured foamable polyurethane composition;
applying the foamable polyurethane composition to a surface of a backing material;
metering the applied polyurethane composition to form a substantially uniform layer of the uncured polyurethane composition having a predetermined thickness;
applying a top layer to the uncured polyurethane composition layer; and
curing the foamable polyurethane composition.

11. The process of claim 10, wherein the foamable polyurethane composition is chemically blown, mechanically frothed, or a combination thereof.

12. The process of claim 10, wherein the backing layer is comprised of a woven textile material.

13. The process of claim 12, wherein the woven textile material is comprised of polypropylene

14. The process of claim 12, wherein the woven textile material is a flat weave woven textile.

15. The process of claim 12, wherein the film is a polymeric film.

16. The process of claim 12, wherein the polymeric film is comprised of polyethylene.

17. The process of claim 12, wherein the foamable polyurethane composition is cured by conveying the woven textile material on a tenter to an oven.
